(19) United States
(12) Patent Application Publication
(10) Pub. No.: US 2025/0118997 A1
(43) Pub. Date: Apr. 10, 2025

(54) METHOD FOR WIRELESS CHARGING AND ELECTRONIC DEVICE SUPPORTING THE SAME

(71) Applicant: Samsung Electronics Co., Ltd., Suwon-si (KR)

(72) Inventors: Baewon PARK, Suwon-si (KR); Seungshik SHIN, Suwon-si (KR); Jinsik CHOI, Suwon-si (KR)

(21) Appl. No.: 18/908,070

(22) Filed: Oct. 7, 2024

(30) Foreign Application Priority Data
Oct. 10, 2023 (KR) 10-2023-0134573

(51) Int. Cl. H02J 50/80; H02J 50/12; H04B 5/79

(52) U.S. Cl. CPC H02J 50/80; H02J 50/12; H04B 5/79

(57) ABSTRACT

An electronic device including a wireless charging coil, a wireless communication circuit, memory storing one or more computer programs, and one or more processors communicatively coupled to the wireless charging coil, the wireless communication circuit, and the memory is provided, wherein the one or more computer programs include computer-executable instructions that, when executed by the one or more processors individually or collectively, cause the electronic device to, by using at least one of the wireless charging coil and the wireless communication circuit in a first state of the electronic device, that is, in a state where the electronic device is powered off, receive a ping signal transmitted from an external electronic device, transmit to the external electronic device a first signal strength packet (SSP) responding to the ping signal, based on receiving of the ping signal, perform first authentication for ultra-fast wireless charging with respect to the external electronic device, based on transmitting of the first SSP, and switch the first state to a second state, that is, a state where the electronic device is powered on, based on detecting of a specified event, while performing the ultra-fast wireless charging based on the first authentication, and wherein the one or more computer programs further include computer-executable instructions that, when executed by the one or more processors individually or collectively, cause the electronic device to, by using at least one of the wireless charging coil and the wireless communication circuit in the second state of the electronic device, transmit a second SSP to the external electronic device.

### CROSS-REFERENCE TO RELATED APPLICATION(S)

This application is based on and claims priority under 35 U.S.C. § 119 (a) of a Korean patent application number 10-2023-0134573, filed on Oct. 10, 2023, in the Korean Intellectual Property Office, the disclosure of which is incorporated by reference herein in its entirety.

### BACKGROUND

### 1. Field

The disclosure relates to a method for wireless charging and an electronic device supporting the method.

### 2. Description of Related Art

In response to the advance of digital convergence in which various information and communication technologies are combined, electronic devices provide various functions and/or various services associated with the functions. Accordingly, there is an emerging issue of efficient management for power which is an essential basis for operating functions and/or services of the electronic device, and as part of this, there is an ongoing proposal on technologies for improving a charging process of a battery which provides the power. For example, the electronic device uses a wireless charging coil disposed therein to process a power signal received wirelessly from an external electronic device, thereby supporting so-called an ultra-fast wireless charging technique which charges the battery of the electronic device to have at least a certain level of power.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for wireless charging and an electronic device supporting the method.

Additional aspects will be set forth in part in the description which follows and, in part, will be apparent from the description, or may be learned by practice of the presented embodiments.

In accordance with an aspect of the disclosure, an electronic device is provided. The electronic device includes a wireless charging coil, a wireless communication circuit, memory storing one or more computer programs, and one or more processors communicatively coupled to the wireless charging coil, the wireless communication circuit, and the memory, wherein, the one or more computer programs include computer-executable instructions that, when executed by the one or more processors individually or collectively, cause the electronic device to, by using at least one of the wireless charging coil and the wireless communication circuit in a first state of the electronic device, that is, in a state where the electronic device is powered off, receive a ping signal transmitted from an external electronic device, transmit to the external electronic device a first signal strength packet (SSP) responding to the ping signal, based on receiving of the ping signal, perform first authentication for ultra-fast wireless charging with respect to the external electronic device, based on transmitting of the first SSP, and switch the first state to a second state, that is, a state where the electronic device is powered on, based on detecting of a specified event, while performing the ultra-fast wireless charging based on the first authentication, and wherein the one or more computer programs further include computer-executable instructions that, when executed by the one or more processors individually or collectively, cause the electronic device to, by using at least one of the wireless charging coil and the wireless communication circuit in the second state of the electronic device, transmit a second SSP to the external electronic device.

In accordance with another aspect of the disclosure, a wireless charging method of an electronic device is provided. The method includes, by using at least one of a wireless charging coil of the electronic device and a wireless communication circuit of the electronic device in a first state of the electronic device, that is, in a state where the electronic device is powered off, receiving a ping signal transmitted from an external electronic device, transmitting to the external electronic device a first SSP responding to the ping signal, based on receiving of the ping signal, performing first authentication for ultra-fast wireless charging with respect to the external electronic device, based on transmitting of the first SSP, and switching the first state to a second state, that is, a state where the electronic device is powered on, based on detecting of a specified event, while performing the ultra-fast wireless charging based on the first authentication, and, by using at least one of the wireless charging coil and the wireless communication circuit in the second state of the electronic device, transmitting a second SSP to the external electronic device.

In accordance with another aspect of the disclosure, one or more non-transitory computer readable storage media storing computer-executable instructions that, when executed by one or more processors individually or collectively, cause the electronic device to perform operations is provided. The operations include, by using at least one of a wireless charging coil of the electronic device and a wireless communication circuit of the electronic device in a first state of the electronic device, that is, in a state where the electronic device is powered off, receiving a ping signal transmitted from an external electronic device, transmitting to the external electronic device a first SSP responding to the ping signal, based on receiving of the ping signal, performing first authentication for ultra-fast wireless charging with respect to the external electronic device, based on transmitting of the first SSP, and switching the first state to a second state, that is, a state where the electronic device is powered on, based on detecting of a specified event, while performing the ultra-fast wireless charging based on the first authentication, and, by using at least one of the wireless charging coil and the wireless communication circuit in the second state of the electronic device, transmitting a second SSP to the external electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device in a network environment according to an embodiment of the disclosure;

FIG. 2 illustrates a power management module and a battery of an electronic device according to an embodiment of the disclosure;

FIG. 3 illustrates a wireless charging environment of an electronic device according to an embodiment of the disclosure;

FIG. 4 illustrates components of an electronic device according to an embodiment of the disclosure;

FIG. 5 illustrates a wireless charging process between an electronic device and an external electronic device according to an embodiment of the disclosure;

FIG. 6 illustrates an operational flow related to wireless charging between an electronic device and an external electronic device according to an embodiment of the disclosure; and

FIG. 7 illustrates an operational flow related to wireless charging between an electronic device and an external electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, it those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

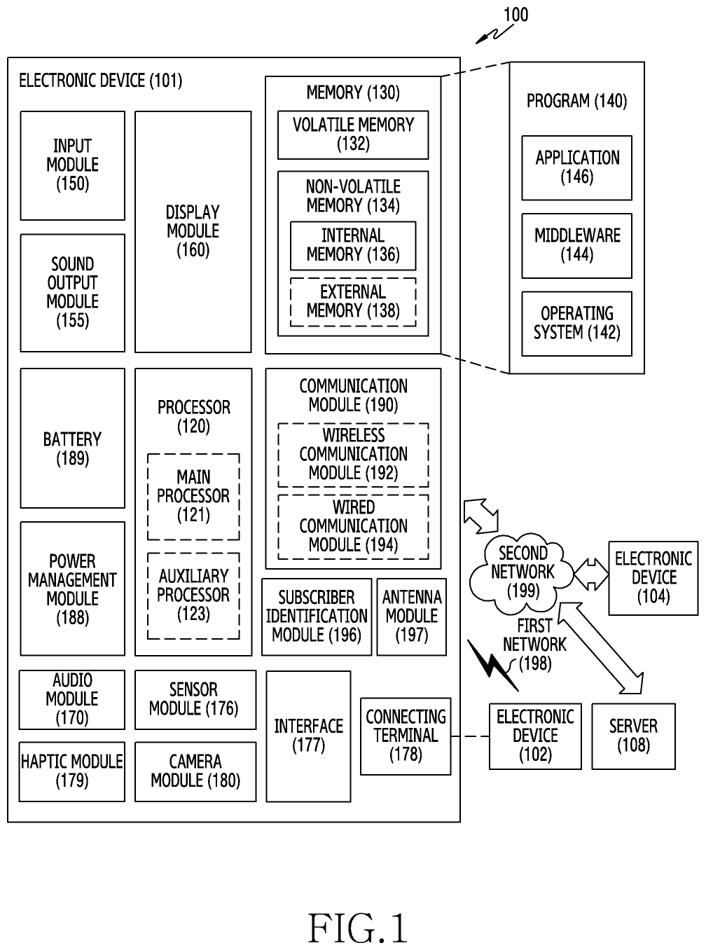

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 and 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

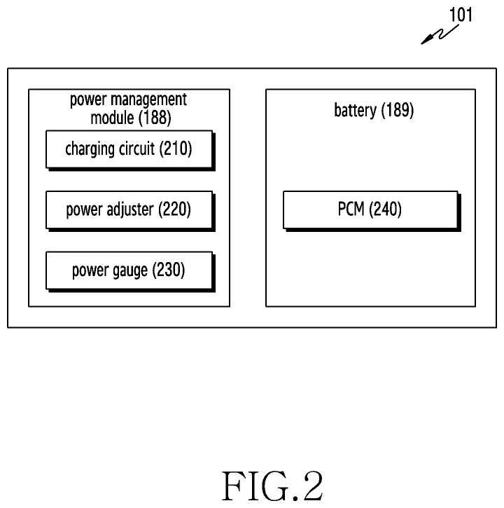

FIG. 2 illustrates a power management module and a battery of an electronic device according to an embodiment of the disclosure.

Referring to FIG. 2, the power management module 188 may include a charging circuit 210, a power adjuster 220, or a power gauge 230. The charging circuit 210 may charge the battery 189 by using power supplied from an external power source outside the electronic device 101. According to an embodiment of the disclosure, the charging circuit 210 may select a charging scheme (e.g., normal charging or quick charging) based at least in part on a type of the external power source (e.g., a power adapter, a USB, or wireless charging), magnitude of power suppliable from the external power source (e.g., about at least 20 Watt), or an attribute of the battery 189, and may charge the battery 189 by using the selected charging scheme. The external power source may be coupled to the electronic device 101, for example, directly via the connecting terminal 178 or wirelessly via the antenna module 197.

The power adjuster 220 may generate multiple powers having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment of the disclosure, the power adjuster 220 may be implemented in the form of a low drop out (LDO) regulator or a switching regulator. The power gauge 230 may measure use state information about the battery 189 (e.g., a capacity, a number of times of charging or discharging, a voltage, or a temperature of the battery 189).

The power management module 188 may determine, using, for example, the charging circuit 210, the power adjuster 220, or the power gauge 230, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment of the disclosure, at least some of the functions of the power management module 188 may be performed by an external control device (e.g., the processor 120).

According to an embodiment of the disclosure, the battery 189 may include a battery protection circuit (i.e., a protection circuit module (PCM)) 240. The PCM 240 may perform one or more of various functions (e.g., a pre-cutoff function) to prevent a performance deterioration of, or a damage to, the battery 189. The PCM 240, additionally or alternatively, may be configured as at least part of a Battery Management System (BMS) capable of performing various functions including cell balancing, measurement of battery capacity, count of a number of charging or discharging, measurement of temperature, or measurement of voltage.

According to an embodiment of the disclosure, at least part of the charging state information or use state information regarding the battery 189 may be measured using a corresponding sensor (e.g., a temperature sensor) of the sensor module 176, the power gauge 230, or the power management module 188. According to an embodiment of the disclosure, the corresponding sensor (e.g., a temperature sensor) of the sensor module 176 may be included as part of the PCM 240, or may be disposed near the battery 189 as a separate device.

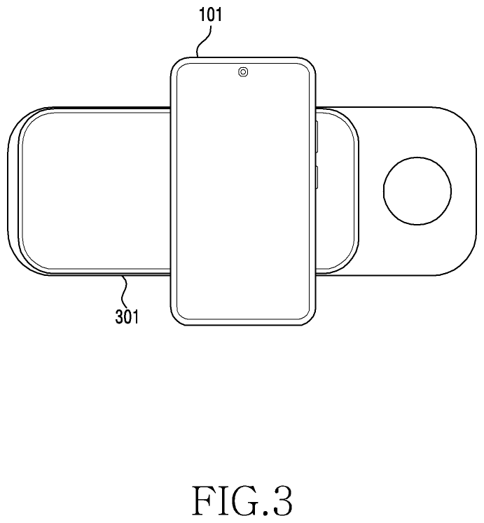

FIG. 3 illustrates a wireless charging environment of an electronic device according to an embodiment of the disclosure.

Referring to FIG. 3, the electronic device 101 according to an embodiment may operate as a power reception device which receives a power signal wirelessly from an external electronic device 301 (e.g., a power transfer device). For example, the electronic device 101 may be disposed (e.g., in contact with the external electronic device 301 or in proximity within a specified distance to the external electronic device 301) on the external electronic device 301, such that at least part of a wireless charging coil (e.g., a wireless charging coil 440L) included in the electronic device 101 is aligned to at least part of a wireless charging coil included in the external electronic device 301, thereby being able to receive the power signal from the external electronic device 301.

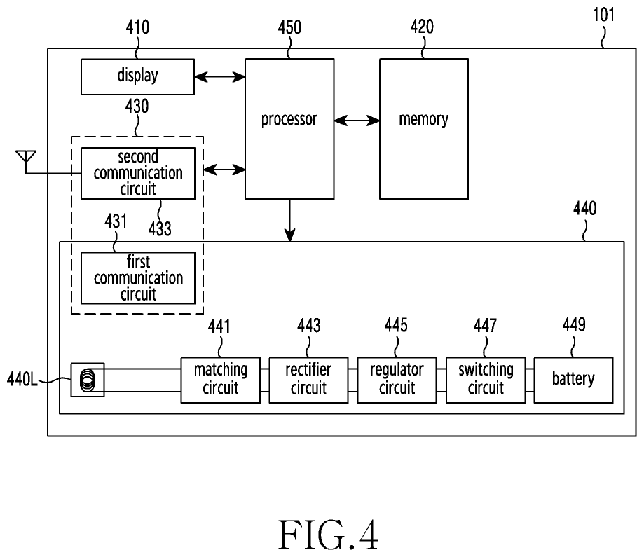

In an embodiment of the disclosure, the electronic device 101 may have a state where a battery (e.g., a battery 449 of FIG. 4) included in the electronic device is discharged or a state where an available power amount of the battery 449 is less than or equal to a specified level. Based on this, the power signal may be received from the external electronic device 301, and the power signal may be processed to charge the battery 449. For example, a magnetic field generated from the wireless charging coil of the external electronic device 301 may generate induced electromotive force in the wireless charging coil 440L of the electronic device 101 disposed on the external electronic device 301, and the electronic device 101 may charge the battery 449 by using the induced electromotive force.

In an embodiment of the disclosure, the electronic device 101 may switch (or change) the state, based on receiving of the power signal from the external electronic device 301 (or based on charging of the battery 449). For example, the electronic device 101 may receive the power signal from the external electronic device 301 in a first state where the electronic device 101 is powered off, and may switch to a second state where the electronic device 101 is powered on upon charging of the battery 449, based on receiving of the power signal. In addition, for example, the electronic device 101 may receive the power signal from the external electronic device 301 in the first state where the electronic device 101 is powered off, and may switch to the second state where the electronic device 101 is powered on based on receiving of a user input for a power key included in the electronic device 101, while the battery 449 is charged based on receiving of the power signal.

In an embodiment of the disclosure, the electronic device 101 may perform authentication for wireless charging with respect to the external electronic device 301 while waiting (or preparing) for receiving of the power signal from the external electronic device 301. For example, the electronic device 101 may transmit information (or a signal or data) required for the authentication to the external electronic device 301, so that the electronic device 101 is authenticated as a valid device in execution of a power sharing function of the external electronic device 301. In addition, for example, in order to execute an ultra-fast wireless charging function for receiving a power signal with at least a specified power amount (e.g., about 15 W) from the external electronic device 301, the electronic device 101 may transmit information (or a signal or data) required for authentication of the ultra-fast wireless charging.

According to various embodiments of the disclosure, the electronic device 101 and the external electronic device 301 may be the same type of devices. For example, each of the electronic device 101 and the external electronic device 301 may include a portable communication device (e.g., a smart phone). Alternatively, according to various embodiments of the disclosure, the electronic device 101 and the external electronic device 301 may be different types of devices which are at least partially different from each other. For example, the electronic device 101 may include a portable communication device (e.g., a smart phone, a wearable device (a smart watch, a smart band, and/or smart glasses), or a sound output device (a wireless earphone)); and the external electronic device 301 may include a wireless charging device (e.g., a wireless charging pad).

FIG. 4 illustrates components of an electronic device according to an embodiment of the disclosure.

Referring to FIG. 4, the electronic device 101 according to an embodiment may use a wireless charging receive data (Rx) function (or a power reception function) to receive a power signal wirelessly from an external electronic device (e.g., the external electronic device 301 of FIG. 3) in contact with or in proximity within a specified distance to the electronic device 101. Regarding this, the electronic device 101 may include a display 410, memory 420, a wireless communication circuit 430, a power reception circuit 440, and at least one processor 450. In various embodiments of the disclosure, at least some of the aforementioned components may be omitted, or other additional components may be further included in the electronic device 101. For example, at least some of the components of the electronic device mentioned according to an embodiment of FIG. 1 may be further included in the electronic device 101.

In an embodiment of the disclosure, the display 410 (e.g., the display module 160 of FIG. 1) may be exposed at least in part to the outside of the electronic device 101 to visually provide a variety of content. For example, the display 410 may display various graphic user interfaces provided by a system and/or application of the electronic device 101 through a screen area, and the graphic user interface may include images, text, symbols, and/or icons representing a wireless charging state of the electronic device 101 (or the battery 449).

In an embodiment of the disclosure, the memory 420 (e.g., the memory 130 of FIG. 1) may store at least one piece of data related to operating of the electronic device 101, or may store at least one instruction related to a functional operation of the components of the electronic device 101. For example, the memory 420 may store a variety of information related to wireless charging of the electronic device 101 (e.g., authentication information on wireless charging).

In an embodiment of the disclosure, the wireless communication circuit 430 (e.g., the wireless communication module 192 of FIG. 1) may support wireless communication between the electronic device 101 and at least one external electronic device. For example, the wireless communication circuit 430 may establish communication (or a communication channel) with respect to the at least one external electronic device according to a specified communication protocol, and may transmit and receive a signal and/or data (or a packet including the data) with respect to the at least one external electronic device through the communication.

According to an embodiment of the disclosure, the wireless communication circuit 430 may include a first communication circuit 431 and a second communication circuit 433. In an embodiment of the disclosure, the first communication circuit 431 may communicate with a wireless communication circuit of the external electronic device (e.g., the external electronic device 301 of FIG. 3), by using a frequency which is the same as the frequency used in the wireless charging coil 440L to wirelessly receive the power signal, or a frequency of a band adjacent to a frequency used to receive the power signal wirelessly. For example, the first communication circuit 431 may support first communication of an in-band type in which a signal and/or data is received from the external electronic device 301 or a signal and/or data is transmitted to the external electronic device 301, by using the wireless charging coil 440L. In an embodiment of the disclosure, the second communication circuit 433 may communicate with a wireless communication circuit of at least one external electronic device by using a frequency of a band different from the frequency used in the wireless charging coil 440L to receive the power signal wirelessly. For example, the second communication circuit 433 may support second communication of an out-band type in which a signal and/or data is received from at least one external electronic device or a signal and/or data is transmitted to the at least one external electronic device, by using at least one antenna (e.g., the antenna module 197 of FIG. 1) included in the electronic device 101. According to various embodiments of the disclosure, the second communication supported by the second communication circuit 433 may include at least one of Bluetooth™ low energy, Bluetooth, Wi-Fi, cellular communication, and near field communication (NFC).

In an embodiment of the disclosure, the power reception circuit 440 (e.g., the charging circuit 210 of FIG. 2) may support wireless charging for the electronic device 101 (or the battery 449). According to an embodiment of the disclosure, the power reception circuit 440 may include at least one of the wireless charging coil 440L which receives a power signal wirelessly from a wireless charging coil of an external electronic device (e.g., the external electronic device 301 of FIG. 3), a matching circuit 441 which maximizes efficiency between a wireless charging coil of the external electronic device 301 and the wireless charging coil 440L of the electronic device 101, a rectifier circuit 443 which rectifies alternating current (AC) power based on the received power signal into direct current (DC) power, a regulator circuit 445 which regulates a charging voltage for the battery 449, the battery 449, and a switching circuit 447 which selectively connects the regulator circuit 445 and the battery 449.

In an embodiment of the disclosure, the at least one processor 450 (e.g., the processor 120 of FIG. 1) may execute programing language code (e.g., instructions) stored in the memory 420 to control various functions or operations of the electronic device 101. For example, the at least one processor 450 may be electrically coupled to the components of the electronic device 101 to transfer (or transmit) to a related component at least one instruction, signal, and/or data accompanied for execution of functions or operations of the electronic device 101. In addition, for example, the at least one processor 450 may provide overall control related to wireless power reception of the electronic device 101, and may generate (or obtain) a variety of signals and/or data related to the wireless power reception to transfer (or transmit) it to the wireless communication circuit 430 (e.g., the first communication circuit 431).

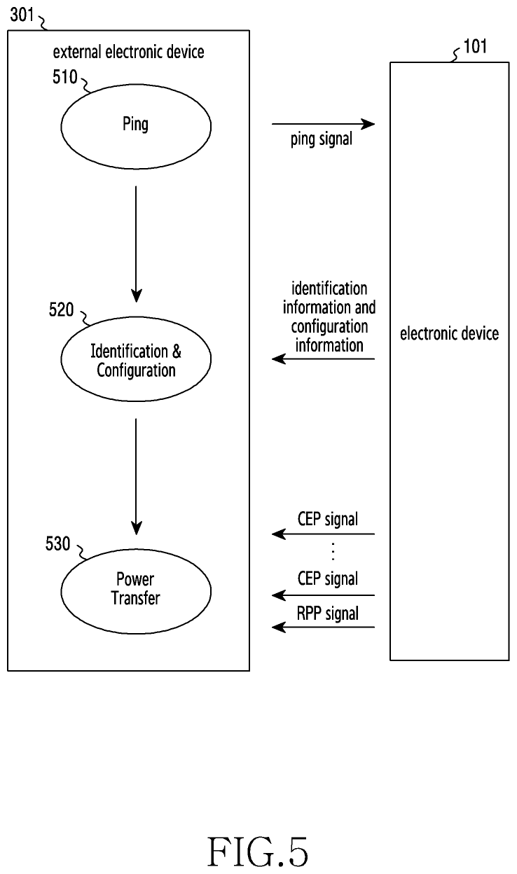

FIG. 5 illustrates a wireless charging process between an electronic device and an external electronic device according to an embodiment of the disclosure.

Hereinafter, in the embodiment of FIG. 5, the electronic device 101 according to an embodiment may operate as a power reception device based on a wireless charging receive data (Rx) function (or a power reception function), and the external electronic device 301 according to an embodiment may operate as a power transfer device based on a wireless charging Transmit data (Tx) function (or a power transfer function).

Referring to FIG. 5, the external electronic device 301 according to an embodiment may perform a ping operation 510 while waiting (or preparing) for wireless charging. For example, the external electronic device 301 may transmit a digital or analog ping signal for detecting a target of wireless charging or for determining whether a signal and/or data transmitted from the external electronic device 301 is reachable to a device (e.g., the electronic device 101) which is in contact with (or in proximity to) the external electronic device 301. In an embodiment of the disclosure, the external electronic device 301 may determine at least one parameter related to transmitting of the ping signal, in the ping operation 510. For example, the external electronic device 301 may determine a parameter related to at least one of a frequency band of the ping signal, a transmission voltage of the ping signal, and a transmission period of the ping signal. In an embodiment of the disclosure, the electronic device 101 may transmit to the external electronic device 301 an ack signal (e.g., a signal including a signal strength packet (SSP)) responding to the ping signal transmitted from the external electronic device 301, and may detect a presence of the electronic device 101 (e.g., the electronic device 101 in contact with the external electronic device 301, or the electronic device 101 in proximity within a specified distance to the external electronic device 301), based on receiving of the ack signal.

In an embodiment of the disclosure, the electronic device 101 may establish a communication connection with the external electronic device 301, in an authentication and configuration operation 520 (identification & configuration), based on detecting of its presence by the external electronic device 301. For example, the electronic device 101 may be coupled to the external electronic device 301 through first communication of an in-band type in which a signal and/or data is transmitted and received by using at least one of a wireless charging coil (e.g., the wireless charging coil 440L of FIG. 4) and a wireless communication circuit (e.g., the first communication circuit 431 of FIG. 4). In various embodiments of the disclosure, a first communication connection between the electronic device 101 and the external electronic device 301 may be established by a series of processes in which any one device transmits a signal of requesting for the first communication connection and another device acknowledges the transmitted signal (or responds to the transmitted signal).

In an embodiment of the disclosure, the electronic device 101 may transmit at least one signal and/or data to the external electronic device 301 by using the first communication. For example, the electronic device 101 may transmit identification information (e.g., a wireless communication ID of the electronic device 101) stored in memory (e.g., the memory 420 of FIG. 4) and capable of authenticating the electronic device 101 to the external electronic device 301. According to an embodiment of the disclosure, the external electronic device 301 may determine the electronic device 101 detected in the ping operation 510 as a valid device in wireless charging, based on a fact that information received from the electronic device 101 corresponds to information (e.g., a wireless communication ID of at least one device authenticated for wireless power sharing with the external electronic device 301) pre-recorded in the external electronic device 301. In an embodiment of the disclosure, the electronic device 101 may transmit to the external electronic device 301, by using the first communication, a variety of configuration information required in order for the electronic device 101 to receive a power signal wirelessly.

In an embodiment of the disclosure, the electronic device 101 may receive the power signal wirelessly from the external electronic device 301, in a power transfer (or reception) operation 530, based on determining of the electronic device 101 as a valid device by the external electronic device 301. According to an embodiment of the disclosure, the electronic device 101 may transmit at least one signal and/or data by using the first communication while receiving the power signal. For example, the electronic device 101 may transmit to the external electronic device 301 a signal and/or data including at least one of a control error packet (CEP) indicating notification information on power (or a power amount) required by the electronic device 101 for wireless charging, a received power packet (RPP) indicating magnitude information of power (or a power amount) with which reception is performed by the electronic device 101, an end power transfer (EPT) requesting for stopping the wireless charging, and a point-to-point protocol (PPP) indicating a data link protocol with respect to the external electronic device 301. According to an embodiment of the disclosure, the external electronic device 301 may regulate at least part of a power signal transmitted wirelessly to the electronic device 101, based on at least one of the CEP and RPP received from the electronic device 101.

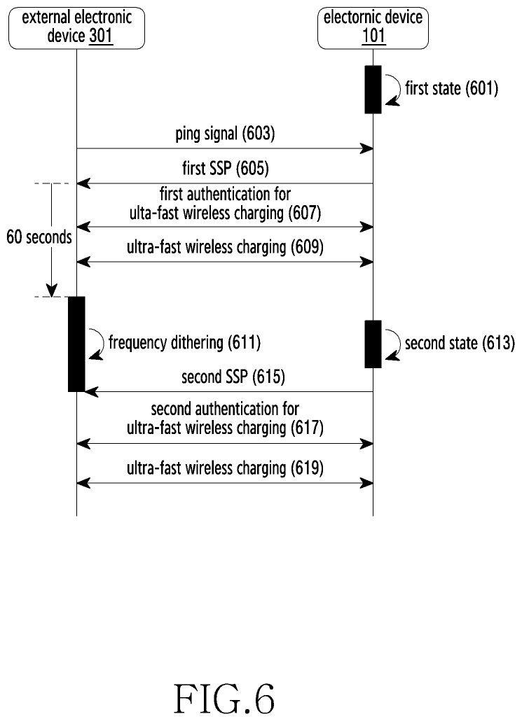

FIG. 6 illustrates an operational flow related to wireless charging between an electronic device and an external electronic device according to an embodiment of the disclosure.

Hereinafter, in the embodiment of FIG. 6, the electronic device 101 according to an embodiment may operate as a power reception device based on a wireless charging receive data (Rx) function (or a power reception function), and the external electronic device 301 according to an embodiment may operate as a power transfer device based on a wireless charging transmit data (Tx) function (or a power transfer function).

In addition, operations of the electronic device 101 and external electronic device 301 mentioned in an embodiment of FIG. 6 may be performed sequentially, but may be not necessarily performed sequentially. For example, orders of the operations mentioned in the embodiment of FIG. 6 may be changed, and at least two operations may be performed in parallel.

Referring to FIG. 6, in operation 601, the electronic device 101 according to an embodiment may have a first state. For example, the electronic device 101 may be disposed (e.g., in contact with the external electronic device 301 or in proximity within a specified distance to the external electronic device 301) on the external electronic device 301 which supports wireless charging, in the first state where the electronic device 101 is powered off. According to an embodiment of the disclosure, in the first state of the electronic device 101, at least one of a display (e.g., the display 410 of FIG. 4), a wireless communication circuit (e.g., the first communication circuit 431 of FIG. 4), a power reception circuit (e.g., the power reception circuit 440 of FIG. 4), and at least one processor (e.g., the at least one processor 450 of FIG. 4) may have a first low-power state of being operated (or driven) based on a driving voltage within a specified first level range (e.g., less than about 3.5V).

In operation 603, the at least one processor 450 of the electronic device 101 according to an embodiment may receive a ping signal from the external electronic device 301. For example, the at least one processor 450 may receive a ping signal transmitted by the external electronic device 301 according to a specified period, through first communication (e.g., in-band communication) which uses at least one of the power reception circuit 440 (e.g., the wireless charging coil 440L) and the first communication circuit 431, while the electronic device 101 has the first state.

In operation 605, the at least one processor 450 of the electronic device 101 according to an embodiment may transmit a first signal strength packet (SSP) to the external electronic device 301. For example, the at least one processor 450 may transmit the first SSP responding to the ping signal transmitted from the external electronic device 301, so that the external electronic device 301 recognizes (or detects) the electronic device 101 of the first state, through the first communication (e.g., the in-band communication) which uses at least one of the power reception circuit 440 (e.g., the wireless charging coil 440L) and the first communication circuit 431, while the electronic device 101 has the first state.

According to an embodiment of the disclosure, the at least one processor 450 of the electronic device 101 may perform a wireless charging process with respect to the external electronic device 301, based on transmitting of the first SSP. For example, based on recognizing (or detecting) of the electronic device 101 of the first state by the external electronic device 301 in accordance with transmission of the first SSP, the at least one processor 450 may use the first communication to transmit, to the external electronic device 301, identification information of the electronic device 101 of the first state (e.g., a wireless communication ID of the electronic device 101) and a variety of configuration information required to receive a power signal wirelessly from the external electronic device 301. In addition, for example, based on determining of the electronic device 101 of the first state as a valid device by the external electronic device 301 according to the identification information, the at least one processor 450 may use the first communication to receive a power signal corresponding to the configuration information wirelessly from the external electronic device 301. In an embodiment of the disclosure, the at least one processor 450 may process the received power signal to charge a battery (e.g., the battery 449 of FIG. 4) in a default charging scheme (e.g., normal charging or quick charging) in a wireless charging system configuration of the electronic device 101 (or a charging scheme pre-specified with respect to the external electronic device 301). According to various embodiments of the disclosure, the at least one processor 450 may control the display 410 to display first content (e.g., a lightning image) representing a charging state of the electronic device 101 (or the battery 449), while the battery 449 is charged based on the charging scheme with a voltage within a first level range (e.g., less than about 3.5V).

In operation 607, the at least one processor 450 of the electronic device 101 according to an embodiment may perform first authentication for ultra-fast wireless charging with respect to the external electronic device 301. For example, the at least one processor 450 may perform the first authentication for the ultra-fast wireless charging, in order to execute an ultra-fast wireless charging function for receiving a power signal of at least a specified power amount (e.g., about 15 W) from the external electronic device 301, based on charging of the battery 449 of the electronic device 101 of the first state with a voltage within a specified second level range (e.g., at least about 3.5V) according to the power signal received wirelessly from the external electronic device 301. According to an embodiment of the disclosure, in the performing of the first authentication for the ultra-fast wireless charging, the at least one processor 450 may have a second low-power state of being operated (or driven) based on a driving voltage within the specified second level range (e.g., at least about 3.5V). According to various embodiments of the disclosure, the at least one processor 450 may control the display 410 to display second content (e.g., a state of charge (SOC) value representing an available power amount (a charging power amount) representing a charging state of the electronic device 101 (or the battery 449)), while the battery 449 is charged with the voltage within the second level range (e.g., at least about 3.5V). In various embodiments of the disclosure, the displaying of the second content by using the display 410 may be maintained while the electronic device 101 performs wireless charging with respect to the external electronic device 301, and the SOC value represented by the second content may vary depending on the charging state (or the charging amount) of the battery 449.

According to an embodiment of the disclosure, the first authentication for the ultra-fast wireless charging may include a series of processes in which the electronic device 101 and the external electronic device 301 mutually share (or transmit and receive) information on whether a corresponding device is able to support an ultra-fast wireless charging function. For example, the at least one processor 450 may use the first communication to transmit to the external electronic device 301 information indicating whether the electronic device 101 is able to execute the ultra-fast wireless charging function and information inquiring whether the external electronic device 301 is able to execute the ultra-fast wireless charging function, and may use the first communication to receive from the external electronic device 301 response information on the inquiry. Alternatively, for example, the at least one processor 450 may use the first communication to receive from the external electronic device 301 information indicating whether the external electronic device 301 is able to execute the ultra-fast wireless charging function and information inquiring whether the electronic device 101 is able to execute the ultra-fast wireless charging function, and may use the first communication to transmit response information on the inquiry.

In operation 609, the at least one processor 450 of the electronic device 101 according to an embodiment may perform the ultra-fast wireless charging with respect to the external electronic device 301. For example, the at least one processor 450 may perform the ultra-fast wireless charging with respect to the external electronic device 301, based on exchanging (or transmitting and receiving) of information indicating whether the corresponding device is able to execute (or support) the ultra-fast wireless charging function, mutually between the electronic device 101 and the external electronic device 301. In an embodiment of the disclosure, based on executing of the ultra-fast wireless charging, the at least one processor 450 may receive a power signal of a specified power amount (e.g., about 15 W) from the external electronic device 301 in accordance with the first communication, and may charge the battery 449 in accordance with the power signal.

In operation 611, the external electronic device 301 according to an embodiment may perform frequency dithering. For example, based on receiving of the first SSP from the electronic device 101, the external electronic device 301 may perform the frequency dithering at a time when a specified time (e.g., about 60 seconds) elapses from the receiving of the first SSP. According to an embodiment of the disclosure, in order to compensate for interference or distortion of an operating frequency for wireless charging with respect to the electronic device 101, the external electronic device 301 may perform the frequency dithering for regulating or restoring the operating frequency.

In operation 613, the at least one processor 450 of the electronic device 101 according to an embodiment may switch (or change) the electronic device 101 from the first state to the second state, based on detecting of a specified event while the ultra-fast wireless charging is performed. For example, based on detecting of an event in which the battery 449 of the electronic device 101 is charged to have a voltage within a specified level range and/or to have a specified power amount in accordance with the ultra-fast wireless charging, the at least one processor 450 may switch the electronic device 101 from the first state to the second state of being powered on, according to a routine defined in a system of the electronic device 101. Alternatively, for example, in a state where the battery 449 is charged to have the voltage within the specified level range and/or to have the specified power amount in accordance with the ultra-fast wireless charging, the at least one processor 450 may switch the electronic device 101 from the first state to the second state of being powered on, based on detecting of an event of receiving a user input for a power key supporting switching of the electronic device 101 between the first state and the second state.

In operation 615, the at least one processor 450 of the electronic device 101 according to an embodiment may transmit a second SSP to the external electronic device 301. For example, based on switching of the electronic device 101 to the second state, the at least one processor 450 may transmit the second SSP to the external electronic device 301 so that the external electronic device 301 re-recognizes (or re-detects) the electronic device 101 of the second state, through the first communication (e.g., in-band communication) which uses at least one of the power reception circuit 440 (e.g., the wireless charging coil 440L) and the first communication circuit 431.

According to an embodiment of the disclosure, the second SSP transmitted by the at least one processor 450 of the electronic device 101 having the second state may function as a trigger which allows the external electronic device 301 to re-perform ultra-fast wireless charging with respect to the electronic device 101 of the second state. In this regard, when the electronic device 101 switches to the second state, in a powered-on process (or a boot-up process) of the electronic device, information on first authentication of ultra-fast wireless charging performed with respect to the external electronic device 301 according to the operation 607 may be initialized (or lost) on the electronic device 101 of the second state. In this case, the at least one processor 450 may use the first communication (e.g., in-band communication) to re-perform (or attempt) authentication for the ultra-fast wireless charging with respect to the external electronic device 301. However, the external electronic device 301 may perform frequency dithering according to the operation 611 after the first authentication for the ultra-fast wireless charging with respect to the electronic device 101, and the frequency dithering performed by the external electronic device 301 may have affect the first communication. Therefore, the authentication for the ultra-fast wireless charging re-performed (or attempted) based on the first communication by the at least one processor 450 may not be reliably performed. Based on this, the at least one processor 450 of the electronic device 101 according to an embodiment may transmit the second SSP to the external electronic device 301, based on switching of the electronic device 101 to the second state, thereby supporting the external electronic device 301 to re-recognize (or detect) the electronic device 101 of the second state. For example, the at least one processor 450 may use the first communication to transmit the second SSP to the external electronic device 301, thereby supporting the external electronic device 301 to stop performing of the frequency dithering and to re-perform a wireless charging process with respect to the electronic device 101 by re-recognizing (or detecting) the electronic device 101 of the second state.

In an embodiment of the disclosure, the external electronic device 301 may stop wireless charging being performed with respect to the electronic device 101 of the second state, based on receiving of the second SSP. In addition, based on stopping of the wireless charging, the external electronic device 301 may re-transmit a ping signal to re-recognize (or detect) the second-state electronic device which is in contact with or in proximity within a specified distance to the external electronic device 301. According to an embodiment of the disclosure, the at least one processor 450 of the electronic device 101 having the second state may transmit a third SSP to the external electronic device 301, based on the first communication (e.g., in-band communication), in order to respond to a ping signal re-transmitted (or re-received) from the external electronic device 301.

In operations 617 and 619, the at least one processor 450 of the electronic device 101 according to an embodiment may re-perform ultra-fast wireless charging with respect to the external electronic device 301, based on transmitting of the third SSP. For example, the at least one processor 450 of the electronic device 101 having the second state may perform second authentication for the ultra-fast wireless charging with respect to the external electronic device 301, and may perform the ultra-fast wireless charging, based on the second authentication. According to an embodiment of the disclosure, identically or similarly to the operation 607, the at least one processor 450 of the electronic device 101 having the second state may perform the second authentication for sharing (or transmitting/receiving) information on whether to support (or execute) the ultra-fast wireless charging function with respect to the external electronic device 301, based on the first communication. For example, the at least one processor 450 may perform the second authentication for the ultra-fast wireless charging with respect to the external electronic device 301 within a specified time range (e.g., a time range before frequency dithering is performed based on receiving of the third SSP by the external electronic device) from a time of transmitting the third SSP. In addition, for example, identically or similarly to the operation 609, based on the second authentication, the at least one processor 450 of the electronic device 101 having the second state may receive a power signal of at least a specified power amount (e.g., about 15 W) corresponding to the ultra-fast wireless charging from the external electronic device 301 through the first communication, and may process the power signal to charge the battery 449.

TABLE 1

[symbol]

[symbol]

indicates data missing or illegible when filed

Table 1 illustrates an experiment for authentication of ultra-fast wireless charging, based on switching of the electronic device 101 to the second state, for a case where the second SSP is not transmitted to the external electronic device 301 (e.g., the embodiment is not applied) and a case whether the second SSP is transmitted to the external electronic device 301 (e.g., the embodiment is applied). Referring to Table 1, when the second SSP is not transmitted to the external electronic device 301, authentication for ultra-fast wireless charging re-performed (or attempted) by the electronic device 101 with respect to the external electronic device 301 by using the first communication (e.g., in-band communication) may identify that an authentication failure occurs 6 times out of 10 times, i.e., the number times of performing experiments, since frequency dithering performed by the external electronic device 301 affects the first communication. However, when transmitting the second SSP to the external electronic device 301, the authentication for the ultra-fast wireless charging re-performed by the electronic device 101 with respect to the external electronic device 301 by using the first communication may identify that the authentication failure occurs 0 times out of 10 times, i.e., the number of times of performing experiments, since the external electronic device 301 stops frequency dithering and wireless charging with respect to the electronic device 101, based on receiving of the second SSP, and re-performs a wireless charging process with respect to the electronic device 101, based on receiving of the third SSP, and thus reliably transmits and receives information related to authentication through the first communication.

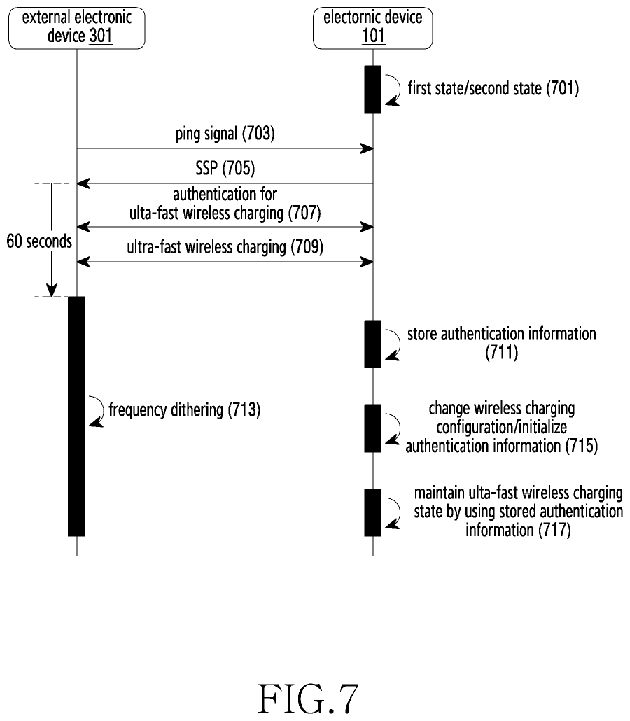

FIG. 7 illustrates an operational flow related to wireless charging between an electronic device and an external electronic device according to an embodiment of the disclosure.

Referring to FIG. 7, the electronic device 101 may operate as a power reception device based on a wireless charging Receive data (Rx) function (or a power reception function), and the external electronic device 301 according to an embodiment may operate as a power transfer device based on a wireless charging Transmit data (Tx) function (or a power transfer function).

In addition, operations of the electronic device 101 and external electronic device 301 mentioned in an embodiment of FIG. 7 may be performed sequentially, but may be not necessarily performed sequentially. For example, orders of the operations mentioned in the embodiment of FIG. 7 may be changed, and at least two operations may be performed in parallel.

In addition, at least some of operations of the electronic device 101 and/or external electronic device 301 mentioned with reference to the embodiment of FIG. 7 may be identical or similar to the aforementioned operations of the electronic device 101 and/or external electronic device described 301 with reference to the embodiment of FIG. 6, and redundant descriptions on the identical or similar operation may be omitted.

Referring to FIG. 7, in operation 701, the electronic device 101 according to an embodiment may have a first state or a second state. For example, the electronic device 101 may be disposed on the external electronic device 301 which supports wireless charging, in the first state where the electronic device 101 is powered off. Alternatively, for example, the electronic device 101 may be disposed on the external electronic device 301, in the second state where the electronic device 101 is powered on.

In operations 703 and 705, at least one processor (e.g., the at least one processor 450 of FIG. 4) of the electronic device 101 according to an embodiment may receive a ping signal from the external electronic device 301, and may transmit a signal strength packet (SSP) responding to the ping signal to the external electronic device 301. For example, the at least one processor 450 may receive the ping signal transmitted according to a specified period from the external electronic device 301, through first communication (e.g., in-band communication) which uses at least one of a power reception circuit (e.g., the wireless charging coil 440L of FIG. 4) and a wireless communication circuit (e.g., the first communication circuit 431 of FIG. 4), while the electronic device 101 has the first state or the second state. In addition, for example, the at least one processor 450 may transmit the SSP so that the external electronic device 301 recognizes (or detects) the electronic device 101 of the first state or the second state, by using the first communication.

According to an embodiment of the disclosure, the at least one processor 450 of the electronic device 101 may perform a wireless charging process with respect to the external electronic device 301, based on transmitting of the SSP. For example, the at least one processor 450 may use the first communication to transmit, to the external electronic device 301, identification information of the electronic device 101 having the first state or the second state and a variety of configuration information required to receive a power signal wirelessly from the external electronic device 301. In addition, for example, the at least one processor 450 may receive a power signal corresponding to the configuration information from the external electronic device 301, and may process the power signal to charge a battery (e.g., the battery 449 of FIG. 4) through a specified charging scheme (e.g., normal charging or quick charging).

In operations 707 and 709, the at least one processor 450 of the electronic device 101 according to an embodiment may perform authentication for ultra-fast wireless charging with respect to the external electronic device 301, and may receive a power signal of at least a specified power amount (e.g., about 15 W) from the external electronic device 301 in accordance with the authentication through the first communication. The at least one processor 450 may process the received power signal of at least the specified power amount to charge the battery 449.

In operation 711, the at least one processor 450 of the electronic device 101 according to an embodiment may store information related to the authentication, based on performing of ultra-fast wireless charging with respect to the external electronic device 301 (or based on completing of authentication for the ultra-fast wireless charging). For example, the at least one processor 450 may at least temporarily store information involved in authentication for the ultra-fast wireless charging (e.g., information indicating that an ultra-fast wireless charging function is executable in each of the electronic device 101 and the external electronic device 301) in memory (e.g., the memory 420 of FIG. 4) of the electronic device 101. Alternatively, for example, the at least one processor 450 may at least temporarily store authentication information on the ultra-fast wireless charging in a storage device (e.g., cache memory or a register) configured inside or outside the at least one processor 450 or a wireless charging circuit.

In operation 713, the external electronic device 301 according to an embodiment may perform frequency dithering. For example, based on receiving of the SSP from the electronic device 101, the external electronic device 301 may perform the frequency dithering at a time when a specified time (e.g., about 60 seconds) elapses from the receiving of the SSP.

In operation 715, the electronic device 101 according to an embodiment may have a change in a configuration for wireless charging (e.g., ultra-fast wireless charging) of the electronic device 101, or authentication for the ultra-fast wireless charging performed with respect to the external electronic device 301 may be initialized (or lost). For example, while performing the ultra-fast wireless charging with respect to the external electronic device 301, the at least one processor 450 of the electronic device 101 may receive a user input for changing the configuration for the wireless charging of the electronic device 101 or may detect a specified event for switching the electronic device 101 of the first state to the second state.

In operation 717, the at least one processor 450 of the electronic device 101 according to an embodiment may maintain the performing of the ultra-fast wireless charging of the electronic device 101. For example, based on changing of the configuration for the wireless charging of the electronic device or detecting of initialization (or loss) of the authentication for the ultra-fast wireless charging, the at least one processor 450 may obtain (or load) authentication information on the ultra-fast wireless charging stored in the memory 420 or the storage device (e.g., cache memory or a register), and may maintain the performing of the ultra-fast wireless charging of the electronic device 101. Based on this, even if there is a change in the configuration for the wireless charging of the electronic device 101 or the authentication for the ultra-fast wireless charging is initialized, the at least one processor 450 of the electronic device 101 may maintain the ultra-fast wireless charging performed with respect to the external electronic device 301 (or return to an ultra-fast wireless charging state), based on authentication information at least temporarily stored (or recorded). Therefore, the authentication for the wireless charging with respect to the external electronic device 301 may not be re-performed.

The electronic device 101 according to an embodiment of the disclosure may include the wireless charging coil 440L, the wireless communication circuit, and the at least one processor 450 electrically coupled to the wireless charging coil and the wireless communication circuit.

According to an embodiment of the disclosure, the at least one processor may be configured to, by using at least one of the wireless charging coil and the wireless communication circuit in a first state of the electronic device, that is, in a state where the electronic device is powered off, receive a ping signal transmitted from the external electronic device 301, transmit to the external electronic device a first signal strength packet (SSP) responding to the ping signal, based on receiving of the ping signal, perform first authentication for ultra-fast wireless charging with respect to the external electronic device, based on transmitting of the first SSP, and switch the first state to a second state, that is, a state where the electronic device is powered on, based on detecting of a specified event, while performing the ultra-fast wireless charging based on the first authentication, and may be configured to, by using at least one of the wireless charging coil and the wireless communication circuit in the second state of the electronic device, transmit a second SSP to the external electronic device.

According to an embodiment of the disclosure, the wireless communication circuit may be configured to support in-band communication which uses a frequency band used in the wireless charging coil to receive a power signal wirelessly from the external electronic device.

According to an embodiment of the disclosure, the at least one processor may be configured to transmit a third SSP to the external electronic device, based on transmitting of the second SSP, and perform second authentication for the ultra-fast wireless charging with respect to the external electronic device, based on transmitting of the third SSP.

According to an embodiment of the disclosure, the at least one processor may be configured to perform the second authentication for the ultra-fast wireless charging with respect to the external electronic device, within a specified time range from a time of transmitting the third SSP.

According to an embodiment of the disclosure, the at least one processor may be configured to transmit the first SSP so that the external electronic device recognizes the electronic device of the first state, and transmit the second SSP so that the external electronic device re-recognizes the electronic device of the second state.

According to an embodiment of the disclosure, the electronic device may further include the battery 449 electrically coupled to the wireless charging coil, the wireless communication circuit, and the at least one processor.

According to an embodiment of the disclosure, the at least one processor may be configured to switch the first state of the electronic device to the second state, based on detecting of the specified event in which the battery is charged to have a specified level of a power amount in accordance with the ultra-fast wireless charging.

According to an embodiment of the disclosure, the electronic device may further include a battery electrically coupled to the wireless charging coil, the wireless communication circuit, and the at least one processor, and a power key which supports switching between the first state of the electronic device and the second state of the electronic device.

According to an embodiment of the disclosure, the at least one processor may be configured to switch the first state of the electronic device to the second state, based on detecting of the specified event in which a user input for the power key is received while the battery is charged to have the specified level of the power amount in accordance with the ultra-fast wireless charging.

According to an embodiment of the disclosure, the at least one processor may be configured to operate with a first low-power state, based on a first driving voltage lower than 3.5V, in the first state of the electronic device, and operate with a second low-power state, based on a second driving voltage of at least 3.5V, in the second state of the electronic device.

According to an embodiment of the disclosure, the electronic device may further include the display 410 electrically coupled to the at least one processor.

According to an embodiment of the disclosure, the at least one processor may be configured to display first content representing a charging state of the electronic device by using the display, in the first state of the electronic device, and display second content representing the charging state of the electronic device by using the display, in the second state of the electronic device.

According to an embodiment of the disclosure, the electronic device may further include the memory 420 electrically coupled to the at least one processor.

According to an embodiment of the disclosure, the at least one processor may be configured to store information on the first authentication temporarily in the memory, based on performing of the first authentication for the ultra-fast wireless charging with respect to the external electronic device.

According to an embodiment of the disclosure, a wireless charging method of the electronic device 101 may include, by using at least one of the wireless charging coil 440L of the electronic device and a wireless communication circuit of the electronic device in a first state of the electronic device, that is, in a state where the electronic device is powered off, receiving a ping signal transmitted from an external electronic device 301 (operation 603), transmitting to the external electronic device a first signal strength packet (SSP) responding to the ping signal, based on receiving of the ping signal (operation 605), performing first authentication for ultra-fast wireless charging with respect to the external electronic device, based on transmitting of the first SSP (operation 607), and switching the first state to a second state, that is, a state where the electronic device is powered on, based on detecting of a specified event, while performing the ultra-fast wireless charging based on the first authentication (operation 613), and may further include, by using at least one of the wireless charging coil and the wireless communication circuit in the second state of the electronic device, transmitting a second SSP to the external electronic device (operation 615).

According to an embodiment of the disclosure, the wireless communication circuit may be configured to support in-band communication which uses a frequency band used in the wireless charging coil to receive a power signal wirelessly from the external electronic device.

According to an embodiment of the disclosure, the transmitting of the second SSP to the external electronic device may include transmitting a third SSP to the external electronic device, based on transmitting of the second SSP, and performing second authentication for the ultra-fast wireless charging with respect to the external electronic device, based on transmitting of the third SSP.

According to an embodiment of the disclosure, the performing of the second authentication for the ultra-fast wireless charging may include performing the second authentication for the ultra-fast wireless charging with respect to the external electronic device, within a specified time range from a time of transmitting the third SSP.

According to an embodiment of the disclosure, the transmitting of the first SSP to the external electronic device may include transmitting the first SSP so that the external electronic device recognizes the electronic device of the first state. The transmitting of the second SSP to the external electronic device may include transmitting the second SSP so that the external electronic device re-recognizes the electronic device of the second state.

According to an embodiment of the disclosure, the switching of the first state to the second state, that is, the state where the electronic device is powered on may include switching the first state of the electronic device to the second state, based on detecting of the specified event in which the battery 449 of the electronic device is charged to have a specified level of a power amount in accordance with the ultra-fast wireless charging.

According to an embodiment of the disclosure, the switching of the first state to the second state, that is, the state where the electronic device is powered on may include switching the first state of the electronic device to the second state, based on detecting of the specified event in which a user input for a power key included in the electronic device is received while a battery of the electronic device is charged to have the specified level of the power amount in accordance with the ultra-fast wireless charging.

According to an embodiment of the disclosure, the wireless charging method may further include operating the at least one processor 450 of the electronic device with a first low-power state, based on a first driving voltage lower than 3.5V, in the first state of the electronic device, and operating the at least one processor with a second low-power state, based on a second driving voltage of at least 3.5V, in the second state of the electronic device.

According to an embodiment of the disclosure, the wireless charging method may further include displaying first content representing a charging state of the electronic device by using the display 410 of the electronic device, in the first state of the electronic device, and displaying second content representing the charging state of the electronic device by using the display, in the second state of the electronic device.

According to an embodiment of the disclosure, the wireless charging method may further include storing information on the first authentication temporarily in the memory 420 of the electronic device, based on performing of the first authentication for the ultra-fast wireless charging with respect to the external electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a wireless charging coil;
a wireless communication circuit;
memory storing one or more computer programs; and
one or more processors communicatively coupled to the wireless charging coil, the wireless communication circuit, and the memory,
wherein the one or more computer programs include computer-executable instructions that, when executed by the one or more processors individually or collectively, cause the electronic device to, by using at least one of the wireless charging coil and the wireless communication circuit in a first state that the electronic device is powered off:
receive a ping signal transmitted from an external electronic device,
transmit to the external electronic device a first signal strength packet (SSP) responding to the ping signal, based on receiving of the ping signal,
perform first authentication for ultra-fast wireless charging with respect to the external electronic device, based on transmitting of the first SSP, and
switch the first state to a second state that the electronic device is powered on, based on detecting of a specified event, while performing the ultra-fast wireless charging based on the first authentication, and
wherein the one or more computer programs further include computer-executable instructions that, when executed by the one or more processors individually or collectively, cause the electronic device to,
by using at least one of the wireless charging coil and the wireless communication circuit in the second state of the electronic device:
transmit a second SSP to the external electronic device.

2. The electronic device of claim 1, wherein the wireless communication circuit is configured to support in-band communication which uses a frequency band used in the wireless charging coil to receive a power signal wirelessly from the external electronic device.

3. The electronic device of claim 1, wherein the one or more computer programs further include computer-executable instructions that, when executed by the one or more processors individually or collectively, cause the electronic device to:
transmit a third SSP to the external electronic device, based on transmitting of the second SSP, and
perform second authentication for the ultra-fast wireless charging with respect to the external electronic device, based on transmitting of the third SSP.

4. The electronic device of claim 3, wherein the one or more computer programs further include computer-executable instructions that, when executed by the one or more processors individually or collectively, cause the electronic device to perform the second authentication for the ultra-fast wireless charging with respect to the external electronic device, within a specified time range from a time of transmitting the third SSP.

5. The electronic device of claim 1, wherein the one or more computer programs further include computer-executable instructions that, when executed by the one or more processors individually or collectively, cause the electronic device to:
transmit the first SSP so that the external electronic device recognizes the electronic device of the first state, and
transmit the second SSP so that the external electronic device re-recognizes the electronic device of the second state.

6. The electronic device of claim 1, further comprising:
a battery electrically coupled to the wireless charging coil, the wireless communication circuit, and the one or more processors,
wherein the one or more computer programs further include computer-executable instructions that, when executed by the one or more processors individually or collectively, cause the electronic device to switch the first state of the electronic device to the second state, based on detecting of the specified event in which the battery is charged to have a specified level of a power amount in accordance with the ultra-fast wireless charging.

7. The electronic device of claim 6, further comprising:
a battery electrically coupled to the wireless charging coil, the wireless communication circuit, and the one or more processors; and
a power key which supports switching between the first state of the electronic device and the second state of the electronic device,
wherein the one or more computer programs further include computer-executable instructions that, when executed by the one or more processors individually or collectively, cause the electronic device to switch the first state of the electronic device to the second state, based on detecting of the specified event in which a user input for the power key is received while the battery is charged to have the specified level of the power amount in accordance with the ultra-fast wireless charging.

8. The electronic device of claim 1, wherein the one or more computer programs further include computer-executable instructions that, when executed by the one or more processors individually or collectively, cause the electronic device to:
operate with a first low-power state, based on a first driving voltage lower than 3.5V, in the first state of the electronic device, and
operate with a second low-power state, based on a second driving voltage of at least 3.5V, in the second state of the electronic device.

9. The electronic device of claim 1, further comprising:
a display electrically coupled to the one or more processors,
wherein the one or more computer programs further include computer-executable instructions that, when executed by the one or more processors individually or collectively, cause the electronic device to:
display first content representing a charging state of the electronic device by using the display, in the first state of the electronic device, and
display second content representing the charging state of the electronic device by using the display, in the second state of the electronic device.

10. The electronic device of claim 1, wherein the one or more computer programs further include computer-executable instructions that, when executed by the one or more processors individually or collectively, cause the electronic device to store information on the first authentication temporarily in the memory, based on performing of the first authentication for the ultra-fast wireless charging with respect to the external electronic device.

11. A wireless charging method of an electronic device, the method comprising:
by using at least one of a wireless charging coil of the electronic device and a wireless communication circuit of the electronic device in a first state that the electronic device is powered off:
receiving a ping signal transmitted from an external electronic device;
transmitting to the external electronic device a first signal strength packet (SSP) responding to the ping signal, based on receiving of the ping signal;
performing first authentication for ultra-fast wireless charging with respect to the external electronic device, based on transmitting of the first SSP; and
switching the first state to a second state that the electronic device is powered on, based on detecting of a specified event, while performing the ultra-fast wireless charging based on the first authentication, and
by using at least one of the wireless charging coil and the wireless communication circuit in the second state of the electronic device:
transmitting a second SSP to the external electronic device.

12. The method of claim 11, further comprising:
supporting, by the wireless communication circuit, in-band communication which uses a frequency band used in the wireless charging coil to receive a power signal wirelessly from the external electronic device.

13. The method of claim 11, wherein the transmitting of the second SSP to the external electronic device comprises:
transmitting a third SSP to the external electronic device, based on transmitting of the second SSP; and
performing second authentication for the ultra-fast wireless charging with respect to the external electronic device, based on transmitting of the third SSP.

14. The method of claim 13, wherein the performing of the second authentication for the ultra-fast wireless charging comprises performing the second authentication for the ultra-fast wireless charging with respect to the external electronic device, within a specified time range from a time of transmitting the third SSP.

15. The method of claim 11,
wherein the transmitting of the first SSP to the external electronic device comprises transmitting the first SSP so that the external electronic device recognizes the electronic device of the first state, and
wherein the transmitting of the second SSP to the external electronic device comprises transmitting the second SSP so that the external electronic device re-recognizes the electronic device of the second state.

16. The method of claim 11, wherein the switching of the first state to the second state, that is, the state where the electronic device is powered on comprises switching the first state of the electronic device to the second state, based on detecting of the specified event in which a battery of the electronic device is charged to have a specified level of a power amount in accordance with the ultra-fast wireless charging.

17. The method of claim 16, wherein the switching of the first state to the second state, that is, the state where the electronic device is powered on comprises switching the first state of the electronic device to the second state, based on detecting of the specified event in which a user input for a power key included in the electronic device is received while a battery of the electronic device is charged to have the specified level of the power amount in accordance with the ultra-fast wireless charging.

18. The method of claim 11, further comprising:
operating at least one processor of the electronic device with a first low-power state, based on a first driving voltage lower than 3.5V, in the first state of the electronic device; and
operating the at least one processor with a second low-power state, based on a second driving voltage of at least 3.5V, in the second state of the electronic device.

19. The method of claim 11, further comprising:
displaying first content representing a charging state of the electronic device by using a display of the electronic device, in the first state of the electronic device; and
displaying second content representing the charging state of the electronic device by using the display, in the second state of the electronic device.

20. The method of claim 11, further comprising:
storing information on the first authentication temporarily in memory of the electronic device, based on performing of the first authentication for the ultra-fast wireless charging with respect to the external electronic device.

21. One or more non-transitory computer-readable storage media storing computer-executable instructions that, when executed by one or more processors individually or collectively, cause an electronic device to perform operations, the operations comprising:
by using at least one of a wireless charging coil of the electronic device and a wireless communication circuit of the electronic device in a first state that the electronic device is powered off:
receiving a ping signal transmitted from an external electronic device;
transmitting to the external electronic device a first signal strength packet (SSP) responding to the ping signal, based on receiving of the ping signal;
performing first authentication for ultra-fast wireless charging with respect to the external electronic device, based on transmitting of the first SSP; and
switching the first state to a second state that the electronic device is powered on, based on detecting of a specified event, while performing the ultra-fast wireless charging based on the first authentication, and
by using at least one of the wireless charging coil and the wireless communication circuit in the second state of the electronic device:
transmitting a second SSP to the external electronic device.

22. The one or more non-transitory computer-readable storage media of claim 21, the operations further comprising supporting, by the wireless communication circuit, in-band communication which uses a frequency band used in the wireless charging coil to receive a power signal wirelessly from the external electronic device.
